(19) United States
(12) Patent Application Publication
(10) Pub. No.: US 2020/0252280 A1
(43) Pub. Date: Aug. 6, 2020

(54) SYSTEMS AND METHODS FOR VALIDATED CONFIGURATION COMPLIANCE ASSURANCE

(71) Applicant: Dell Products L.P., Round Rock, TX (US)

(72) Inventors: Timothy M. LAMBERT, Austin, TX (US); Robert R. LEYENDECKER, Austin, TX (US); Jordan CHIN, Austin, TX (US); Peilin YAO, Austin, TX (US)

(73) Assignee: Dell Products L.P., Round Rock, TX (US)

(21) Appl. No.: 16/266,453

(22) Filed: Feb. 4, 2019

(51) Int. Cl. H04L 12/24; G06F 11/14

(52) U.S. Cl. CPC H04L 41/0816; H04L 41/0873; G06F 9/4401; H04L 41/0856; G06F 11/1417; H04L 41/0863

(57) ABSTRACT

An information handling system comprising may include a host system processor and a management controller communicatively coupled to the host system processor and configured to perform out-of-band management of the information handling system. The management controller may be further configured to, during boot of the information handling system read a known configuration for the information handling system from a storage resource accessible to the management controller, determine a current configuration of the information handling system, compare the known configuration to the current configuration, and in response to a mismatch between the known configuration and the current configuration, report an indication of the mismatch to a user of the information handling system and receive a desired user action for responding to the mismatch.

### TECHNICAL FIELD

The present disclosure relates in general to information handling systems, and more particularly to methods and systems for assuring compliance with validated configurations of an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Over time, physical configurations of information handling systems are growing increasingly complex. Historically, factory-shipped configurations of information handling systems were often checked once during manufacturing diagnostic checking and often never again in the field. In other cases, cursory misconfiguration coverage was embedded in base system firmware to call out hard configuration errors. While such configuration checking may be acceptable in specialized products, such configuration checking may not be suitable if system requirements require re-use and leverage of information handling system base boards and peripheral cards, along with internal connectivity flexibility enabled by newer systems.

Newer information handling systems may include system configurations with more complex couplings of backplanes, cables, risers, and/or other internal modules than older generations. Thus, a user of an information handling system may reconfigure the information handling system to a logically correct configuration, but a configuration which is not validated or factory supported. Mechanisms to detect the presence of such non-validated configurations are lacking using traditional approaches.

### SUMMARY

In accordance with the teachings of the present disclosure, the disadvantages and problems associated with assuring compliance with validated information handling system configurations may be reduced or eliminated.

In accordance with embodiments of the present disclosure, an information handling system comprising may include a host system processor and a management controller communicatively coupled to the host system processor and configured to perform out-of-band management of the information handling system. The management controller may be further configured to, during boot of the information handling system read a known configuration for the information handling system from a storage resource accessible to the management controller, determine a current configuration of the information handling system, compare the known configuration to the current configuration, and in response to a mismatch between the known configuration and the current configuration, report an indication of the mismatch to a user of the information handling system and receive a desired user action for responding to the mismatch.

In accordance with these and other embodiments of the present disclosure, a method may include, during boot of an information handling system, reading a known configuration for the information handling system from a storage resource, determining a current configuration of the information handling system, comparing the known configuration to the current configuration, and in response to a mismatch between the known configuration and the current configuration, reporting an indication of the mismatch to a user of the information handling system and receiving a desired user action for responding to the mismatch.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to, during boot of an information handling system: read a known configuration for the information handling system from a storage resource; determine a current configuration of the information handling system; compare the known configuration to the current configuration; and in response to a mismatch between the known configuration and the current configuration, report an indication of the mismatch to a user of the information handling system and received a desired user action for responding to the mismatch.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a flow chart of an example method for initial population of an original configuration and an updated configuration of an information handling system, in accordance with embodiments of the present disclosure; and

FIG. 3 illustrates a flow chart of an example method for assuring compliance of an information handling system with a validated configuration, in accordance with embodiments of the present disclosure.

### DETAILED DESCRIPTION

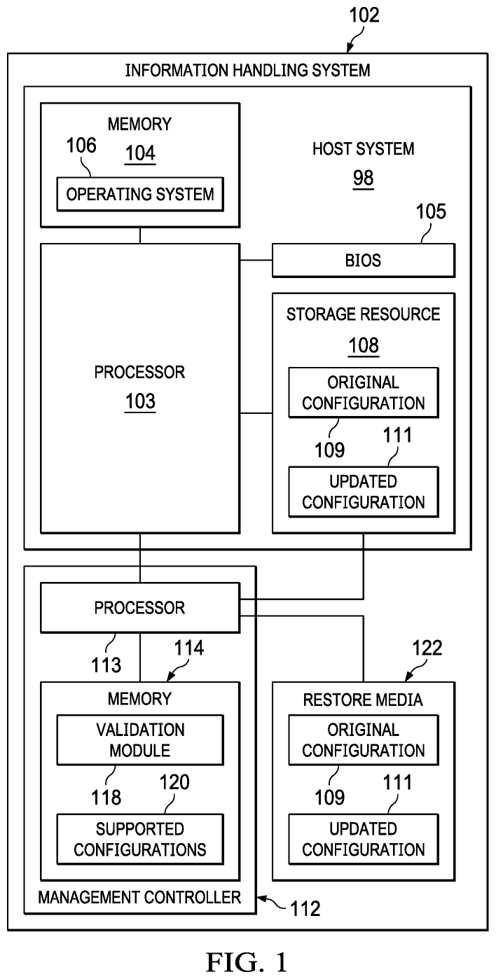

Preferred embodiments and their advantages are best understood by reference to FIGS. 1 through 3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example information handling system 102, in accordance with embodiments of the present disclosure. In some embodiments, information handling system 102 may comprise a personal computer. In some embodiments, information handling system 102 may comprise or be an integral part of a server. In other embodiments, information handling system 102 may comprise a portable information handling system (e.g., a laptop, notebook, tablet, handheld, smart phone, personal digital assistant, etc.). As depicted in FIG. 1, information handling system 102 may include a processor 103, a memory 104 communicatively coupled to processor 103, a BIOS 105 communicatively coupled to processor 103, a storage resource 108 communicatively coupled to processor 103, a management controller 112 communicatively coupled to processor 103, and restore media 122 communicatively coupled to management controller 112. In operation, processor 103, memory 104, BIOS 105, and storage resource 108 may comprise at least a portion of a host system 98 of information handling system 102. For purposes of clarity and exposition, information handling system 102 has been depicted to comprise only a single host system 98. In some embodiments, information handling system 102 may comprise a plurality of host systems 98.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions, or aggregation of programs of executable instructions, configured to manage and/or control the allocation and usage of hardware resources such as memory, processor time, disk space, and input and output devices, and provide an interface between such hardware resources and application programs hosted by operating system 106. Active portions of operating system 106 may be transferred to memory 104 for execution by processor 103. Although operating system 106 is shown in FIG. 1 as stored in memory 104, in some embodiments operating system 106 may be stored in storage media accessible to processor 103 (e.g., storage resource 108 and/or other storage media), and active portions of operating system 106 may be transferred from such storage media to memory 104 for execution by processor 103.

A BIOS 105 may include any system, device, or apparatus configured to identify, test, and/or initialize information handling resources of information handling system 102, and/or initialize interoperation of information handling system 102 with other information handling systems. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105. In these and other embodiments, BIOS 105 may comprise boot firmware configured to be the first code executed by processor 103 when information handling system 102 is booted and/or powered on. As part of its initialization functionality, code for BIOS 105 may be configured to set components of information handling system 102 into a known state, so that one or more applications (e.g., an operating system or other application programs) stored on compatible media (e.g., disk drives) may be executed by processor 103 and given control of information handling system 102.

Storage resource 108 may be communicatively coupled to processor 103 and may include any system, device, or apparatus operable to store information processed by processor 103. Storage resource 108 may include, for example, network attached storage, one or more direct access storage devices (e.g., hard disk drives), one or more optical media drives (e.g., CD-ROM, DVD drives, Blu-Ray disk drive, etc.), and/or one or more sequential access storage devices (e.g., tape drives). As shown in FIG. 1, storage resource 108 may have stored thereon an original configuration 109 and an updated configuration 111.

As described in greater detail below, original configuration 109 may comprise a table, map, list, database, or other data structure defining an original configuration of information handling system 102 as factory-configured and factory-validated prior to delivery of information handling system 102 to its user. Also, as described below, updated configuration 111 may comprise a table, map, list, database, or other data structure defining a configuration of information handling system 102. In some instances, updated configuration 111 may constitute a user and/or service technician updated configuration that differs from that of original configuration 109. However, in other instances (e.g., prior to updating of the original configuration 109), updated configuration 111 may be identical to original configuration 109.

Management controller 112 may be configured to provide management facilities for management of information handling system 102. Such management may be made by management controller 112 even if information handling system 102 is powered off or powered to a standby state. Management controller 112 may include a processor 113 and a memory 114. In certain embodiments, management controller 112 may include or may be an integral part of a baseboard management controller (BMC) or a remote access controller (e.g., a Dell Remote Access Controller or Integrated Dell Remote Access Controller).

Processor 113 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 113 may interpret and/or execute program instructions and/or process data stored in memory 114 and/or another component of information handling system 102 or management controller 112. As shown in FIG. 1, processor 113 may be communicatively coupled to processor 103. Such coupling may be via a Universal Serial Bus (USB), System Management Bus (SMBus), Peripheral Component Interconnect Express (PCIe) bus, and/or one or more other communications channels.

Memory 114 may be communicatively coupled to processor 113 and may include any system, device, or apparatus configured to retain program instructions and/or data for a period of time (e.g., computer-readable media). Memory 114 may include RAM, EEPROM, a PCMCIA card, flash memory, magnetic storage, opto-magnetic storage, or any suitable selection and/or array of volatile or non-volatile memory that retains data after power to management controller 112 is turned off. As shown in FIG. 1, memory 114 may have stored thereon a validation module 118 and supported configurations 120.

Validation module 118 may comprise one or more programs of instructions configured to determine a current configuration for information handling system 102, compare the current configuration to original configuration 109, update configuration 111, and/or supported configurations 120, and based on the comparison, validate the current configuration for information handling system 102 and/or provide information to a user of information handling system 102 regarding deviations of the current configuration from the validated configurations defined in original configuration 109, update configuration 111, and/or supported configurations 120, as described in greater detail below.

Supported configurations 120 may set forth a plurality of configurations of information handling system 102 which have been factory-validated for information handling system 102.

Restore media 122 may be communicatively coupled to management controller 112 and may include any system, device, or apparatus operable to store information, in particular information that may be needed to restore operation of one or more components of information handling system 102 in the event of component failure or data loss. In some embodiments, restore media 122 may include a Restore Serial Peripheral Interface (RSPI) configured to store particular information about information handling system 102, including a unique identifier (e.g., service tag number) of information handling system 102. As shown in FIG. 1, restore media 122 may have stored thereon backup versions of original configuration 109 and updated configuration 111.

As used herein, a “configuration” may comprise a collection of information defining an inventory of information handling resources of information handling system 102, including hardware resources, firmware resources, software resources, and/or connectivity of hardware resources to one another.

As used herein “factory-validated” may mean that a particular configuration for an information handling system has been tested by a manufacturer or other provider of the information handling system and verified by such manufacturer or other provider such that an operating system with such factory-validated configuration is capable of performing in accordance with technical and/or operational specifications for the information handling system. While an information handling system may operate correctly and without error for some logical configurations which are not factory-validated, such operation may be sub-optimal and may not meet the technical and/or operational specifications for the information handling system.

In addition to processor 103, memory 104, storage resource 108, management controller 112, and restore media 122, information handling system 102 may include one or more other information handling resources.

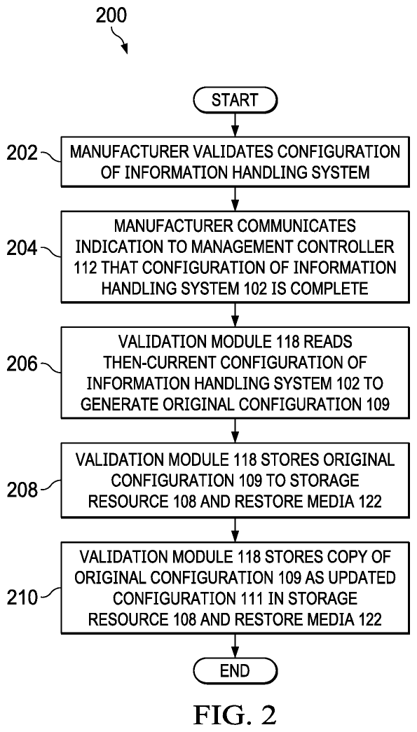

FIG. 2 illustrates a flow chart of an example method 200 for initial population of original configuration 109 and updated configuration 111 of information handling system 102, in accordance with embodiments of the present disclosure. According to some embodiments, method 200 may begin at step 202. As noted above, teachings of the present disclosure may be implemented in a variety of configurations of information handling system 102. As such, the preferred initialization point for method 200 and the order of the steps comprising method 200 may depend on the implementation chosen.

At step 202, during manufacture of information handling system 102, a manufacturer or other provider of information handling system 102 may validate the configuration of information handling system 102, for example by comparison with a database of known validated configurations. At step 204, the manufacturer or other provider of information handling system 102 may communicate an indication to management controller 112 that configuration of information handling system 102 is complete. In response, at step 206, validation module 118 of management controller 112 may read the then-current configuration of information handling system 102 in order to generate original configuration 109. At step 208, validation module 118 of management controller 112 may store such original configuration 109 to storage resource 108 and restore media 122. At step 210, validation module 118 of management controller 112 may make an identical copy of original configuration 109 and store such copy as updated configuration 111 in storage resource 108 and restore media 122. After step 210, method 200 may end.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented in whole or part using validation module 118 and/or any other system operable to implement method 200. In certain embodiments, method 200 may be implemented partially or fully in software and/or firmware embodied in computer-readable media.

Although FIG. 2 and the description thereof above discusses the storing of original configuration 109 and updated configuration 111 at factory build of information handling system 102, it is understood that storing of original configuration 109 and updated configuration 111 may also be performed by an authorized technician (e.g., a manufacturer-certified technician) in order to account for changes to a validated configuration for information handling system 102.

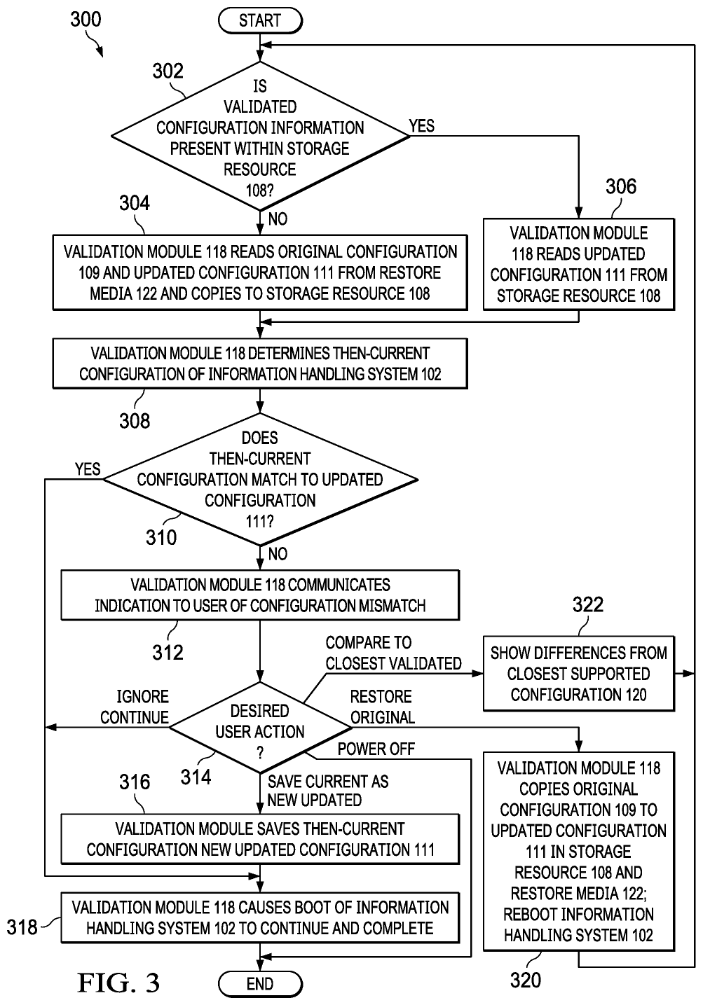

FIG. 3 illustrates a flow chart of an example method 300 for assuring compliance of information handling system 102 with a validated configuration, in accordance with embodiments of the present disclosure. According to some embodiments, method 300 may begin at step 302. As noted above, teachings of the present disclosure may be implemented in a variety of configurations of information handling system 102. As such, the preferred initialization point for method 300 and the order of the steps comprising method 300 may depend on the implementation chosen.

At step 302, validation module 118 of management controller 112 may, during a boot of management controller 112, determine if validated configuration information is present within storage resource 108. Validated configuration information may be absent from storage resource 108 in the event of a replacement of storage resource 108 or a planar upon which storage resource 108 resides, or for other reasons. If validated configuration information is present within storage resource 108, method 300 may proceed to step 306. Otherwise, method 300 may proceed to step 304.

At step 304, responsive to validated configuration information being absent from storage resource 108, validation module 118 of management controller 112 may read original configuration 109 and updated configuration 111 from restore media 122 and copy original configuration 109 and updated configuration 111 to storage resource 108. After completion of step 304, method 300 may proceed to step 308.

At step 306, responsive to validated configuration information being present within storage resource 108, validation module 118 of management controller 112 may read updated configuration 111 from storage resource 108.

At step 308, validation module 118 of management controller 112 may determine the then-current configuration of information handling system 102. At step 310, validation module 118 of management controller 112 may compare the then-current configuration to updated configuration 111. If the then-current configuration matches updated configuration 111, then method 300 may proceed to step 318. Otherwise, method 300 may proceed to step 312.

At step 312, responsive to then-current configuration of information handling system 102 failing to match updated configuration 111, validation module 118 of management controller 112 may communicate an indication to a user of information handling system 102 (e.g., via a display device) that the then-current configuration differs from its last configuration. In some embodiments, validation module 118 of management controller 112 may also communicate the differences between the then-current configuration and updated configuration 111.

At step 314, validation module 118 of management controller 112 may receive from the user a desired action to take in response to the failure of the then-current configuration to match updated configuration 111. For instance, options provided to a user by validation module 118 of management controller 112 may include, without limitation: (a) an option to power off information handling system 102 in order for the user to address the mismatched configuration (in response to which, method 300 may end); (b) an option to ignore the mismatched configuration and continue boot of information handling system 102 (in response to which, method 300 may proceed to step 318); (c) an option to save the then-current configuration of information handling system 102 as a new updated configuration 111 (in which case method 300 may proceed to step 316); (d) an option to compare the then-current configuration to its closest validated configuration set forth in supported configurations 120 (in which case method 300 may proceed to step 322), and (e) an option to restore original configuration 109 (in which case method 300 may proceed to step 320).

At step 316, in response to the user choosing to save the then-current configuration of information handling system 102 as a new updated configuration 111, validation module 118 of management controller 112 may save the then-current configuration of information handling system 102 as a new updated configuration 111.

At step 318, validation module 118 of management controller 112 may cause boot of information handling system 102 to continue and complete, after which method 300 may end.

At step 320, in response to the user choosing to restore original configuration 109, validation module 118 of management controller 112 may copy original configuration 109 to updated configuration 111 in both storage resource 108 and restore media 122, and cause reboot of information handling system 102, which may cause method 300 to execute again.

At step 322, in response to the user choosing to compare the then-current configuration to its closest validated configuration set forth in supported configurations 120, validation module 118 of management controller 112 may find the configuration set forth in supported configurations 120 that differs the least from the then-current configuration, display an indication to the user regarding such differences, from which the user may reconfigure information handling system 102 and cause reboot of information handling system 102, which may cause method 300 to execute again.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented in whole or part using validation module 118 and/or any other system operable to implement method 300. In certain embodiments, method 300 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a host system processor; and
a management controller communicatively coupled to the host system processor and configured to perform out-of-band management of the information handling system, the management controller further configured to, during boot of the information handling system:
read a known configuration for the information handling system from a storage resource accessible to the management controller;
determine a current configuration of the information handling system;
compare the known configuration to the current configuration; and
in response to a mismatch between the known configuration and the current configuration, report an indication of the mismatch to a user of the information handling system and receive a desired user action for responding to the mismatch.

2. The information handling system of claim 1, wherein the known configuration is an original factory-validated configuration of the information handling system.

3. The information handling system of claim 1, wherein the known configuration is a configuration from a previous boot session of the information handling system.

4. The information handling system of claim 3, wherein:
the desired user action is to restore an original factory-validated configuration of the information handling system; and
the management controller restores the original factory-validated configuration such that the original factory-validated configuration is the known configuration during a subsequent boot session of the information handling system.

5. The information handling system of claim 1, wherein:
the desired user action is to ignore the mismatch; and
the management controller causes the information handling system to complete boot.

6. The information handling system of claim 1, wherein:
the desired user action is to save the current configuration as an updated configuration; and
the management controller saves the current configuration such that the current configuration is the known configuration during a subsequent boot session of the information handling system.

7. The information handling system of claim 1, wherein:
the desired user action is to compare the configuration to a closest validated configuration; and
the management controller is configured to identify the closest validated configuration from a plurality of configurations and provide an indication to the user of differences between the current configuration and the closest validated configuration.

8. The information handling system of claim 1, wherein the management controller is further configured to:
attempt to read the known configuration from the storage resource;
read the known configuration from the storage resource if the known configuration is present within the storage resource; and
read the known configuration from restore media if the known configuration is absent from the storage resource.

9. The information handling system of claim 8, wherein the management controller is further configured to copy the known configuration from the restore media to the storage resource if the known configuration is absent from the storage resource.

10. A method comprising, during boot of an information handling system:
reading a known configuration for the information handling system from a storage resource;
determining a current configuration of the information handling system;
comparing the known configuration to the current configuration; and
in response to a mismatch between the known configuration and the current configuration, reporting an indication of the mismatch to a user of the information handling system and receiving a desired user action for responding to the mismatch.

11. The method of claim 10, wherein the known configuration is an original factory-validated configuration of the information handling system.

12. The method of claim 10, wherein the known configuration is a configuration from a previous boot session of the information handling system.

13. The method of claim 12, wherein:
the desired user action is to restore an original factory-validated configuration of the information handling system; and
the method further comprises restoring the original factory-validated configuration such that the original factory-validated configuration is the known configuration during a subsequent boot session of the information handling system.

14. The method of claim 10, wherein:
the desired user action is to ignore the mismatch; and
the method further comprises causing the information handling system to complete boot.

15. The method of claim 10, wherein:
the desired user action is to save the current configuration as an updated configuration; and
the method further comprises saving the current configuration such that the current configuration is the known configuration during a subsequent boot session of the information handling system.

16. The method of claim 10, wherein:
the desired user action is to compare the configuration to a closest validated configuration; and
the method further comprises identifying the closest validated configuration from a plurality of configurations and provide an indication to the user of differences between the current configuration and the closest validated configuration.

17. The method of claim 10, the method further comprising:
attempting to read the known configuration from the storage resource;
reading the known configuration from the storage resource if the known configuration is present within the storage resource; and
reading the known configuration from restore media if the known configuration is absent from the storage resource.

18. The method of claim 17, the method further comprising copying the known configuration from the restore media to the storage resource if the known configuration is absent from the storage resource.

19. An article of manufacture comprising:
a non-transitory computer-readable medium; and
computer-executable instructions carried on the computer-readable medium, the instructions readable by a processor, the instructions, when read and executed, for causing the processor to, during boot of an information handling system:
read a known configuration for the information handling system from a storage resource;
determine a current configuration of the information handling system;
compare the known configuration to the current configuration; and
in response to a mismatch between the known configuration and the current configuration, report an indication of the mismatch to a user of the information handling system and received a desired user action for responding to the mismatch.
